(19) United States
(12) Patent Application Publication
(10) Pub. No.: US 2026/0143022 A1
(43) Pub. Date: May 21, 2026

(54) Signalling of Certain Additional Information For A DASH Preselection

(71) Applicant: Bytedance Inc., Los Angeles, CA (US)

(72) Inventor: Ye-Kui WANG, San Diego, CA (US)

(21) Appl. No.: 19/447,688

(22) Filed: Jan. 13, 2026

Related U.S. Application Data
(63) Continuation of application No. PCT/US2024/037816, filed on Jul. 12, 2024.
(60) Provisional application No. 63/513,756, filed on Jul. 14, 2023.

(51) Int. Cl. H04L 65/70; H04L 65/756

(52) U.S. Cl. CPC H04L 65/70; H04L 65/756

(57) ABSTRACT

A mechanism for processing video data is disclosed herein. The mechanism includes determining a value of an additional property descriptor (AdditionalPropertiesDescriptor) included in a Dynamic Adaptive Streaming over Hypertext Transfer Protocol (DASH) preselection element. A conversion is performed between a visual media data and a bitstream based on the AdditionalPropertiesDescriptor.

### CROSS-REFERENCE TO RELATED APPLICATION

This application is a continuation of International Patent Application No. PCT/US2024/037816 filed on Jul. 12, 2024, which claims the priority to and benefits of U.S. Provisional Patent Application 63/513,756, filed on Jul. 14, 2023. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining a value of an additional property descriptor (AdditionalPropertiesDescriptor) included in a Dynamic Adaptive Streaming over Hypertext Transfer Protocol (DASH) preselection element; and performing a conversion between a visual media data and a bitstream based on the AdditionalPropertiesDescriptor.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises determining a value of an additional property descriptor (AdditionalPropertiesDescriptor) included in a Dynamic Adaptive Streaming over Hypertext Transfer Protocol (DASH) preselection element; and generating a bitstream based on the determining.

A fifth aspect relates to a method for storing bitstream of a video comprising: determining a value of an additional property descriptor (AdditionalPropertiesDescriptor) included in a Dynamic Adaptive Streaming over Hypertext Transfer Protocol (DASH) preselection element: generating a bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

FIG. 8 is a flowchart for an example method of video processing.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. INITIAL DISCUSSION

This document is related to video streaming. Specifically, this disclosure is related to signalling of certain additional information for a preselection in Dynamic Adaptive Streaming over Hypertext Transfer Protocol (DASH) in a manner such that the additional information supersedes or overrides some other information signalled for the preselection. The ideas may be applied individually or in various combinations, for media streaming systems, e.g., based on the DASH standard or its extensions.

### 2. FURTHER DISCUSSION

### 2.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is a coding standard targeting at 50% bitrate reduction as compared to HEVC.

The Versatile Video Coding (VVC) standard (ITU-T H.266|ISO/IEC 23090-3) [3][4] and the associated Versatile Supplemental Enhancement Information (VSEI) standard (ITU-T H.274|ISO/IEC 23002-7) [5][6] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360°) immersive media.

The Essential Video Coding (EVC) standard (ISO/IEC 23094-1) is another video coding standard under development by MPEG.

### 2.2 File Format Standards

Media streaming applications are typically based on the internet protocol (IP), Transmission Control Protocol (TCP), and Hypertext Transfer Protocol (HTTP) transport methods, and typically rely on a file format such as the ISO base media file format (ISOBMFF) [7]. One such streaming system is dynamic adaptive streaming over HTTP (DASH) [8]. For using a video format with ISOBMFF and DASH, a file format specification specific to the video format, such as the AVC file format and the HEVC file format in [9], would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session. Similarly, for using an image format with ISOBMFF, a file format specification specific to the image format, such as the AVC image file format and the HEVC image file format in [10], would be needed.

The VVC video file format, the file format for storage of VVC video content based on ISOBMFF is under development by MPEG. An example specification of the VVC video file format is included in [11].

The VVC image file format, the file format for storage of image content coded using VVC, based on ISOBMFF, is under development by MPEG. An example specification of the VVC image file format is included in [12].

2.3 DASH

In Dynamic adaptive streaming over HTTP (DASH) [8], there may be multiple representations for video and/or audio data of multimedia content, different representations may correspond to different coding characteristics (e.g., different profiles or levels of a video coding standard, different bitrates, different spatial resolutions, etc.). The manifest of such representations may be defined in a Media Presentation Description (MPD) data structure. A media presentation may correspond to a structured collection of data that is accessible to DASH streaming client device. The DASH streaming client device may request and download media data information to present a streaming service to a user of the client device. A media presentation may be described in the MPD data structure, which may include updates of the MPD.

A media presentation may contain a sequence of one or more periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

An example DASH streaming procedure is shown by the following steps:
1) The client gets the MPD.
2) The client estimates the downlink bandwidth, and selects a video representation and an audio representation according to the estimated downlink bandwidth and the codec, decoding capability, display size, audio language setting, etc.
3) Unless the end of the media presentation is reached, the client requests media segments of the selected representations and presents the streaming content to the user.
4) The client keeps estimating the downlink bandwidth. When the bandwidth changes to a direction (e.g., becomes lower) significantly, the client selects a different video representation to match the newly estimated bandwidth, and go to step 3.

### 2.4 Preselection in DASH

Subclause 5.3.11 of the DASH specification [8] specifies the support of preselection, through either a preselection descriptor or a preselection element. The Preselection element is specified as follows.

### 5.3.11.3 Semantics of Preselection Element

As an alternative to the Preselection descriptor, Preselections may also be defined through the Preselection element as provided in Table 26. The selection of Preselections is based on the contained attributes and elements in the Preselection element.

TABLE 26
Semantics of PreSelection element

| Element or Attribute Name | Use | Description |
|---|---|---|
| Preselection | | |
| @id | OD | specifies the id of the Preselection. This shall be unique |
| | default = 1 | within one Period. |
| @preselectionComponents | M | specifies the ids of the contained Adaptation Sets or |
| | | Content Components that belong to this Preselection as |
| | | white space separated list in processing order. The first |
| | | id defines the Main Adaptation Set. |
| @lang | O | same semantics as in Table 5 for @lang attribute. |
| @order | OD | specifies the conformance rules for Representations in |
| | Default: | Adaptation Sets within the Preselection. |
| | ‘undefined’ | When set to ‘undefined’, the Preselection follows the |
| | | conformance rules for Multi-Segment Tracks in |
| | | subclause 5.3.11.5.1. |
| | | When set to ‘time-ordered’, the Preselection follows the |
| | | conformance rules for Time-Ordered Segment Tracks |
| | | in subclause 5.3.11.5.2. |
| | | When set to ‘fully-ordered’, the Preselection follows the |
| | | conformance rules for Fully-Ordered Segment Tracks |
| | | in subclause 5.3.11.5.3. In this case, order in the |
| | | @preselectionComponents attribute specifies the |
| | | component order. |
| Accessibility | 0 . . . N | specifies information about accessibility scheme. |
| | | For more details, refer to subclauses 5.8.1 and 5.8.4.3. |
| Role | 0 . . . N | specifies information on role annotation scheme. |
| | | For more details, refer to subclauses 5.8.1 and 5.8.4.2. |
| Rating | 0 . . . N | specifies information on rating scheme. |
| | | For more details, refer to subclauses 5.8.1 and 5.8.4.4. |
| Viewpoint | 0 . . . N | specifies information on viewpoint annotation scheme. |
| | | For more details, refer to subclauses 5.8.1 and 5.8.4.5. |
| CommonAttributesElements | — | specifies the common attributes and elements |
| | | (attributes and elements from base type |
| | | RepresentationBaseType). For details, see subclause |
| | | 5.3.7. |

1. Key
2. For attributes: M = mandatory, O = Optional, OD = optional with default value, CM = conditionally mandatory
3. For elements: <minOccurs> . . . <maxOccurs> (N = unbounded)
4. Elements are bold; attributes are non-bold and preceded with an @.

### 5.3.11.4 XML Syntax

```
  <xs:complexType name=“PreselectionType”>
    <xs:annotation>
      <xs:documentation xml:lang=“en”>
      Preselection
    </xs:documentation>
    </xs:annotation>
    <xs:complexContent>
      <xs:extension base=“RepresentationBaseType”>
        <xs:sequence>
          <xs:element name=“Accessibility” type=“DescriptorType” minOccurs=“0”
maxOccurs=“unbounded”/>
          <xs:element name=“Role” type=“DescriptorType” minOccurs=“0”
maxOccurs=“unbounded”/>
          <xs:element name=“Rating” type=“DescriptorType” minOccurs=“0”
maxOccurs=“unbounded”/>
          <xs:element name=“Viewpoint” type=“DescriptorType” minOccurs=“0”
maxOccurs=“unbounded”/>
        </xs:sequence>
        <xs:attribute name=“id” type=“StringNoWhitespaceType” default=“1”/>
        <xs:attribute name=“preselectionComponents” type=“StringVectorType” use=“required”/>
        <xs:attribute name=“lang” type=“xs:language”/>
        <xs:attribute name=“order” type=“PreselectionOrderType” default=“undefined”/>
      </xs:extension>
    </xs:complexContent>
  </xs:complexType>
  <xs:simpleType name=“PreselectionOrderType”>
    <xs:annotation>
      <xs:documentation xml:lang=“en”>
      Preselection Order type
    </xs:documentation>
    </xs:annotation>
    <xs:restriction base=“xs:string”>
      <xs:enumeration value=“undefined”/>
      <xs:enumeration value=“time-ordered”/>
      <xs:enumeration value=“fully-ordered”/>
    </xs:restriction>
  </xs:simpleType>
```

### 5.3.11.5 Conformance Rules

### 5.3.11.5.1 Conformance Rules for Multi-Segment Tracks

Where multiple Adaptation Sets indicate this type of ordering, each Adaptation Set and the contained Representations follow the regular conformance rules for multi-segment tracks as defined in subclause 5.3.5.1.

No additional conformance rules are defined for the Representations in different Adaptation Sets within Preselections.

### 5.3.11.2 Conformance Rules for Time-Ordered Segment Track

Where multiple Adaptation Sets indicate this type of ordering, each Adaptation Set and the contained Representations follow the conformance rules for multi-segment tracks as defined in subclause 5.3.11.5.1.

In addition, the concatenation of the following shall represent a conforming Segment track as defined in subclause 4.5.4 and conforming to the media type as specified in the @mimeType attribute for the Representation of the Main Adaptation Set:
An Initialization Segment of one Representation of the Main Adaptation Set (specified by the first id in the @preselectionComponents attribute or the Preselection Descriptor, and
media segments/subsegments of one Representation from each Adaptation Set referenced in the Preselection ordered by non-decreasing first decode times.

NOTE. This does not constrain the order of segments with the same first decode time.

If Adaptation Sets within a Preselection are time-ordered as defined above, the Representations of all Adaptation Sets referenced by the Preselection should be segment/subsegment aligned as defined in subclause 5.3.3.5.

5.3.11.5.3 Conformance rules for Fully-Ordered Segment Track

Where multiple Adaptation Sets indicate this type of ordering, each Adaptation Set and the contained Representations follow the conformance rules for multi-segment tracks as defined in subclause 5.3.11.5.1.

In addition, the concatenation of the following shall represent a conforming Segment track as defined in subclause 4.5.4 and conforming to the media type as specified in the @mimeType attribute for the Representation of the Main Adaptation Set:
An Initialization Segment of one Representation of the Main Adaptation Set (specified by the first id in the @preselectionComponents attribute or the Preselection Descriptor), and
media segments/subsegments of one Representation from each Adaptation Set referenced in the Preselection ordered first by non-decreasing decode times and then by position in the list given in @preselectionComponents.

If Adaptation Sets referenced by a Preselection are fully ordered as defined above, the Representations of all Adaptation Sets referenced by the Preselection shall be segment/subsegment aligned as defined in subclause 5.3.3.5.

### 2.5 Preselection in DASH with an @Interleaving Attribute

MPEG input document m64333 [13] proposes the addition of an @interleaving attribute to the preselection element in DASH, immediately following the @order attribute.

The semantics and the extensible markup language (XML) syntax of the proposed an a interleaving attribute are as follows:

| | | |
|---|---|---|
| @interleaving | O | provides the interleaving instructions to be used for |
| | | interleaving samples or groups of samples of this |
| | | representation with other representations in this |
| | | preselection. |
| | | The syntax, semantics, and the conformance rules |
| | | are defined by a decoder specification or related |
| | | documents. |
| | | The information provided in this attribute supersede |
| | | @order value. |

```
  <xs:complexType name=“PreselectionType”>
    <xs:annotation>
      <xs:documentation xml:lang=“en”>
      Preselection
    </xs:documentation>
    </xs:annotation>
    <xs:complexContent>
      <xs:extension base=“RepresentationBaseType”>
        <xs:sequence>
          <xs:element name=“Accessibility” type=“DescriptorType” minOccurs=“0”
maxOccurs=“unbounded”/>
          <xs:element name=“Role” type=“DescriptorType” minOccurs=“0”
maxOccurs=“unbounded”/>
          <xs:element name=“Rating” type=“DescriptorType” minOccurs=“0”
maxOccurs=“unbounded”/>
          <xs:element name=“Viewpoint” type=“DescriptorType” minOccurs=“0”
maxOccurs=“unbounded”/>
        </xs:sequence>
        <xs:attribute name=“id” type=“StringNoWhitespaceType” default=“1”/>
        <xs:attribute name=“preselectionComponents” type=“StringVectorType” use=“required”/>
        <xs:attribute name=“lang” type=“xs:language”/>
        <xs:attribute name=“order” type=“PreselectionOrderType” default=“undefined”/>
        <xs:attribute name=“interleaving” type=“xs:string”/>
      </xs:extension>
    </xs:complexContent>
  </xs:complexType>
  <xs:simpleType name=“PreselectionOrderType”>
    <xs:annotation>
      <xs:documentation xml:lang=“en”>
      Preselection Order type
    </xs:documentation>
    </xs:annotation>
    <xs:restriction base=“xs:string”>
      <xs:enumeration value=“undefined”/>
      <xs:enumeration value=“time-ordered”/>
      <xs:enumeration value=“fully-ordered”/>
    </xs:restriction>
  </xs:simpleType>
```

### 3. TECHNICAL PROBLEMS SOLVED BY DISCLOSED TECHNICAL SOLUTIONS

In an example design for the addition of an @interleaving attribute to the preselection element in DASH as proposed in the MPEG input document m64333 [13] has the following problems:

First, specifying that the information provided in the new attribute @interleaving supersede the @order attribute has a backward compatibility problem for legacy DASH clients. If the content provider includes this new attribute, it certainly intends that the information provided by this attribute is used. However, legacy DASH clients do not recognize this new attribute and are not able to use the information provided by this new attribute. Not sending the a order attribute does not solve the problem, as even when the @order attribute is not present there is a default meaning.

### 4. A LISTING OF SOLUTIONS AND EMBODIMENTS

To solve the above-described problems, methods as summarized below are disclosed. The aspects should be considered as examples to explain the general concepts and should not be interpreted in a narrow way. Furthermore, these examples can be applied individually or combined in any manner.
1) To solve the first problem, a new descriptor, e.g., named AdditionalPropertiesDescriptor, is defined. This new descriptor may be included in the preselection element.
   a. In one example, the new descriptor shall be an Essential Property Descriptor with a particular @schemeIdURI value, e.g., “urn:mpeg:dash:preselection:essentialproperties:202x”, where “202x” could for example be “2024”, “2025”, or “2026”.
   b. In one example, the new descriptor contains an attribute @interleaving with the same or similar semantics as the @interleaving attribute in the MPEG input document m64333.
   c. In one example, the new descriptor contains an element, which contains an attribute @interleaving with the same or similar semantics as the @interleaving attribute in the MPEG input document m64333.
   d. In one example, a DASH client that recognizes the Prelection element containing an AdditionalPropertiesDescriptor element but does not recognize the AdditionalPropertiesDescriptor element ignores the entire Prelection element.

### 5. EMBODIMENTS

Below are some example embodiments for the aspects summarized above in Section 4.

### 5.1 Embodiment 1

This embodiment is for items 1, 1.a, 1.b, and 1.d as summarized above in Section 4.

An EssentialProperty element with the @schemeIdUri attribute equal to urn:mpeg:dash:preselection:essentialproperties:202x, named AdditionalPropertiesDescriptor, may be present in a Preselection element. A DASH client that recognizes the Prelection element containing an AdditionalPropertiesDescriptor element but does not recognize the AdditionalPropertiesDescriptor element ignores the entire Prelection element.

The AdditionalPropertiesDescriptor element shall include the @interleaving attribute, with the following semantics:

Semantics of AdditionalPropertiesDescriptor element

| Element or | | |
|---|---|---|
| Attribute Name | Use | Description |
| @interleaving | O | provides the interleaving instructions to be used |
| | | for interleaving samples or groups of samples of |
| | | this representation with other representations in |
| | | this preselection. |
| | | The syntax, semantics, and the conformance rules |
| | | are defined by a decoder specification or related |
| | | documents. |
| | | The information provided in this attribute |
| | | supersede the value of the @order attribute in the |
| | | Preselection element containing this |
| | | AdditionalPropertiesDescriptor element. |

Key
For attributes: M = mandatory, O = Optional, OD = optional with default value, CM = conditionally mandatory
For elements: <minOccurs> . . . <maxOccurs> (N = unbounded)
Elements are bold; attributes are non-bold and preceded with an @.

The XML syntax of the @interleaving attribute is as follows:
<xs:attribute name=“interleaving” type=“xs:string”/>

### 6. REFERENCES

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266|ISO/IEC 23090-3, “Versatile Video Coding”, 2020.
[4] B. Bross, J. Chen, S. Liu, Y.-K. Wang (editors), “Versatile Video Coding (Draft 10),” JVET-S2001.
[5] Rec. ITU-T Rec. H.274|ISO/IEC 23002-7, “Versatile Supplemental Enhancement Information Messages for Coded Video Bitstreams”, 2020.
[6] J. Boyce, V. Drugeon, G. Sullivan, Y.-K. Wang (editors), “Versatile supplemental enhancement information messages for coded video bitstreams (Draft 5),” JVET-S2007.
[7] ISO/IEC 14496-12: “Information technology—Coding of audio-visual objects—Part 12: ISO base media file format”.
[8] ISO/IEC 23009-1: “Information technology—Dynamic adaptive streaming over HTTP (DASH)—Part 1: Media presentation description and segment formats”.
[9] ISO/IEC 14496-15: “Information technology—Coding of audio-visual objects—Part 15: Carriage of network abstraction layer (NAL) unit structured video in the ISO base media file format”.
[10] ISO/IEC 23008-12: “Information technology—High efficiency coding and media delivery in heterogeneous environments—Part 12: Image File Format”.
[11] ISO/IEC JTC 1/SC 29/WG 03 output document N0035, “Potential improvements on Carriage of VVC and EVC in ISOBMFF”, November 2020.
[12] ISO/IEC JTC 1/SC 29/WG 03 output document N0038, “Information technology-High efficiency coding and media delivery in heterogeneous environments—Part 12: Image File Format—Amendment 3: Support for VVC, EVC, slideshows and other improvements (CD stage)”, November 2020.
[13] Iraj Sodagar, “[DASH][AMD2] Proposed update to Preselection for alignment with ISOBMFF/common media application format (CMAF)/DASH exploration,” MPEG input document m64333, Geneva, CH, July 2023.

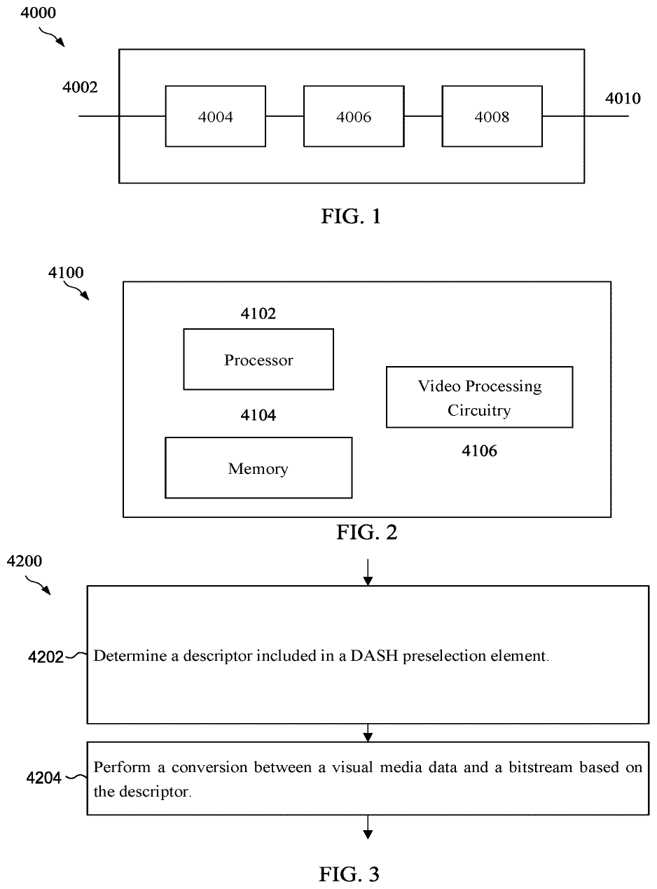

FIG. 1 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer. Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 3 is a flowchart for an example method 4200 of video processing. The method 4200 determines a descriptor included in a Dynamic Adaptive Streaming over Hypertext Transfer Protocol (DASH) preselection element at step 4202. A conversion between a visual media data and a bitstream is performed based on the descriptor at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

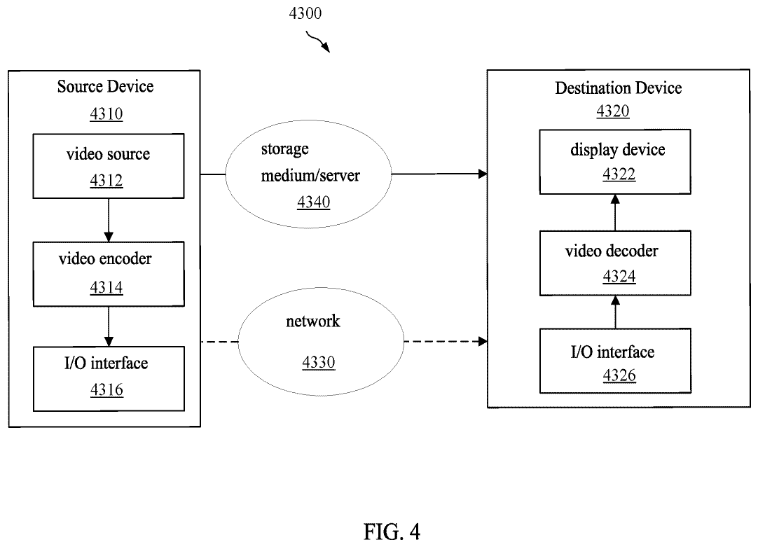

FIG. 4 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

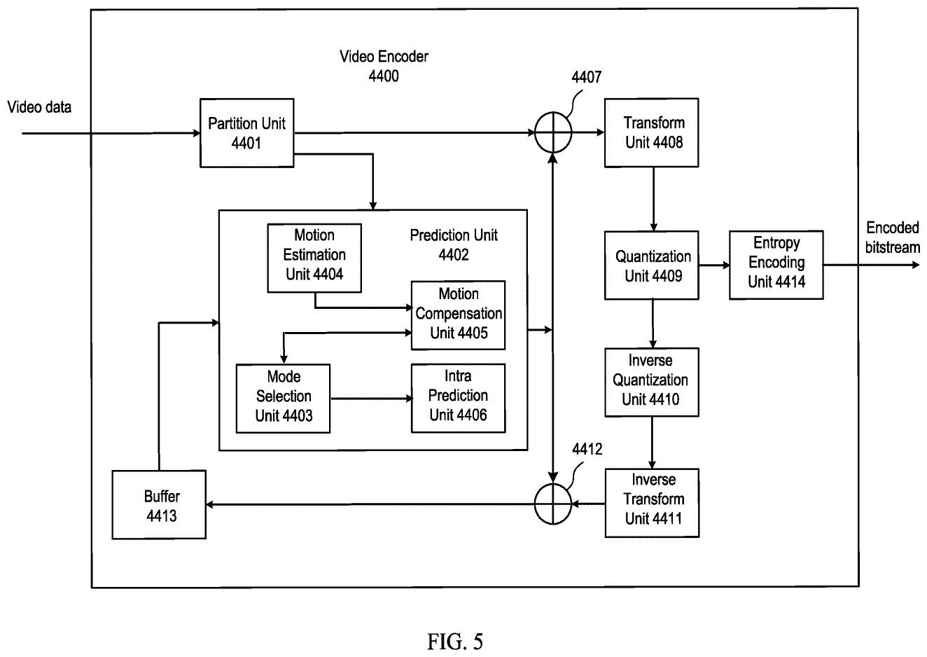

FIG. 5 is a block diagram illustrating an example of video encoder 4400, which may be video encoder 4314 in the system 4300 illustrated in FIG. 4. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

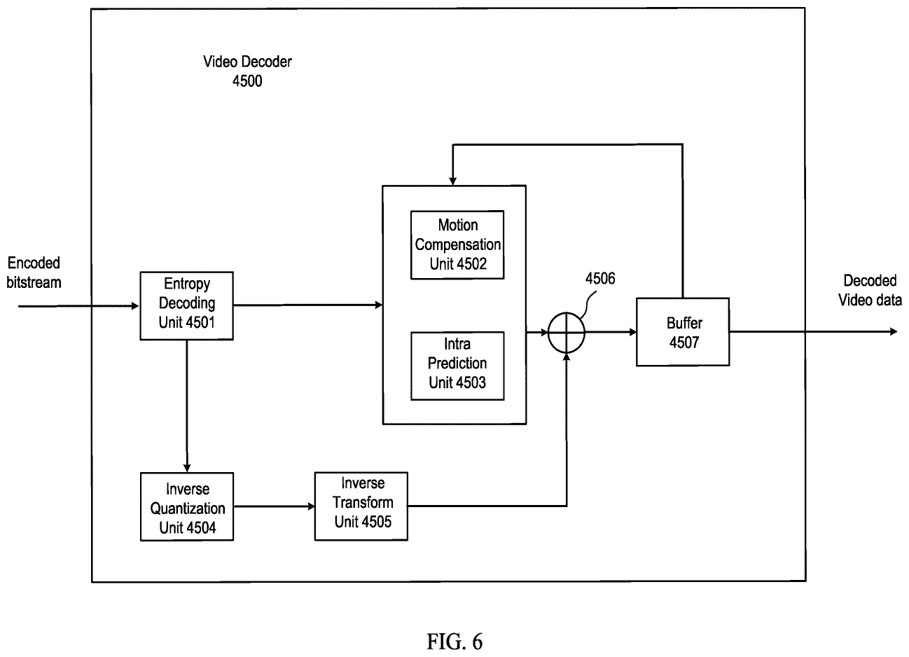

FIG. 6 is a block diagram illustrating an example of video decoder 4500 which may be video decoder 4324 in the system 4300 illustrated in FIG. 4. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

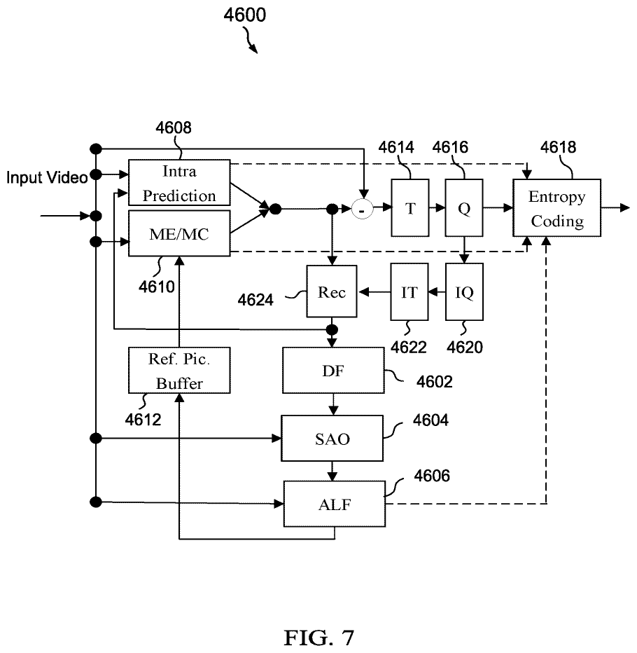

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600) further includes an intra prediction component 4608 and a motion estimation/compensation (ME/MC) component 4610) configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

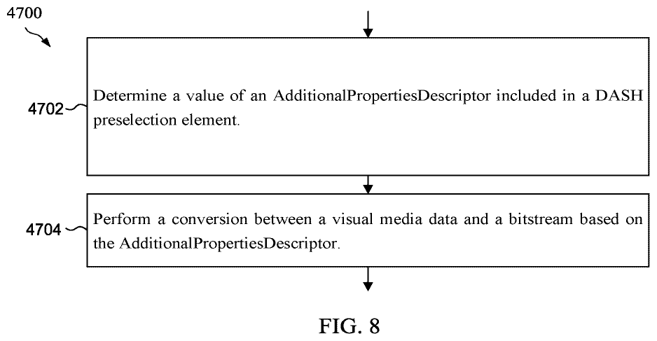

FIG. 8 is a flowchart for an example method 4700 of video processing. The method 4700 determines a value of an additional property descriptor (AdditionalPropertiesDescriptor) included in a Dynamic Adaptive Streaming over Hypertext Transfer Protocol (DASH) preselection element at step 4702. A conversion between a visual media data and a bitstream based on the AdditionalPropertiesDescriptor at step 4704. The conversion may include encoding at an encoder, decoding at a decoder, or combinations thereof.

It should be noted that the method 4700 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4700. Further, the method 4700 can be performed by a non-transitory computer readable medium comprising a computer program product for use by a video coding device. The computer program product comprises computer executable instructions stored on the non-transitory computer readable medium such that when executed by a processor cause the video coding device to perform the method 4700.

A listing of solutions preferred by some examples is provided next.

The following solutions show examples of techniques discussed herein.

1. A method for processing media data comprising: determining a descriptor included in a Dynamic Adaptive Streaming over Hypertext Transfer Protocol (DASH) preselection element; and performing a conversion between a visual media data and a bitstream based on the descriptor.

2. The method of solution 1, wherein the descriptor is an additional property descriptor (AdditionalPropertiesDescriptor).

3. The method of any of solutions 1-2, wherein the descriptor is an Essential Property Descriptor with a particular @schemeIdURI value, including “urn:mpeg:dash:preselection:essentialproperties:202x”, where “202x” is “2024”, “2025”, or “2026”.

4. The method of any of solutions 1-3, wherein the descriptor contains an @interleaving attribute.

5. The method of any of solutions 1-4, wherein the descriptor contains an element, which contains an @interleaving attribute.

6. The method of any of solutions 1-5, wherein a DASH client that recognizes the Prelection element containing an AdditionalPropertiesDescriptor element and does not recognize the AdditionalPropertiesDescriptor element ignores the entire Prelection element.

7. An apparatus for processing video data comprising: a processor; and a non-transitory memory with instructions thereon, wherein the instructions upon execution by the processor, cause the processor to perform the method of any of solutions 1-6.

8. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-6.

9. A non-transitory computer-readable recording medium storing a bitstream of a video which is generated by a method performed by a video processing apparatus, wherein the method comprises: determining a descriptor included in a Dynamic Adaptive Streaming over Hypertext Transfer Protocol (DASH) preselection element; and generating a bitstream based on the determining.

10. A method for storing bitstream of a video comprising: determining a descriptor included in a Dynamic Adaptive Streaming over Hypertext Transfer Protocol (DASH) preselection element: generating a bitstream based on the determining; and storing the bitstream in a non-transitory computer-readable recording medium.

11. A method, apparatus, or system described in the present document.

The following solutions show further examples of techniques discussed herein.

1. A method for processing media data comprising: determining a value of an additional property descriptor (AdditionalPropertiesDescriptor) included in a Dynamic Adaptive Streaming over Hypertext Transfer Protocol (DASH) preselection element; and performing a conversion between a visual media data and a bitstream based on the AdditionalPropertiesDescriptor.

2. The method of solution 2, wherein the AdditionalPropertiesDescriptor is an Essential Property Descriptor with a particular @schemeIdURI value, including “urn:mpeg:dash:preselection:essentialproperties:202x”.

3. The method of any of solutions 1-2, wherein 202x is 2024, 2025, or 2026.

4. The method of any of solutions 1-3, wherein the AdditionalPropertiesDescriptor contains an @interleaving attribute.

5. The method of any of solutions 1-4, wherein the AdditionalPropertiesDescriptor contains an element, which contains an @interleaving attribute.

6. The method of any of solutions 1-5, wherein a DASH client that recognizes the DASH prelection element containing the AdditionalPropertiesDescriptor element and does not recognize the AdditionalPropertiesDescriptor element ignores the entire DASH prelection element.

7. The method of any of solutions 1-6, wherein the fa interleaving attribute provides interleaving instructions to be used for interleaving samples or groups of samples of a current representation with other representations in a current preselection.

8. The method of any of solutions 1-7, wherein the conversion includes encoding the visual media data into the bitstream.

9. The method of any of solutions 1-7, wherein the conversion includes decoding the visual media data from the bitstream.

10. An apparatus for processing video data comprising: a processor; and a non-transitory memory with instructions thereon, wherein the instructions upon execution by the processor, cause the processor to perform the method of any of solutions 1-9.

11. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-9.

12. A non-transitory computer-readable recording medium storing a bitstream of a video which is generated by a method performed by a video processing apparatus, wherein the method comprises: determining a value of an additional property descriptor (AdditionalPropertiesDescriptor) included in a Dynamic Adaptive Streaming over Hypertext Transfer Protocol (DASH) preselection element; and generating a bitstream based on the determining.

13. The non-transitory computer-readable recording medium of solution 12, wherein the AdditionalPropertiesDescriptor is an Essential Property Descriptor with a particular @schemeIdURI value, including “urn:mpeg:dash:preselection:essentialproperties:202x”.

14. The non-transitory computer-readable recording medium of any of solutions 12-13, wherein 202x is 2024, 2025, or 2026.

15. The non-transitory computer-readable recording medium of any of solutions 12-14, wherein the AdditionalPropertiesDescriptor contains an @interleaving attribute.

16. The non-transitory computer-readable recording medium of any of solutions 12-15, wherein the AdditionalPropertiesDescriptor contains an element, which contains an @interleaving attribute.

17. The non-transitory computer-readable recording medium of any of solutions 12-16, wherein a DASH client that recognizes the DASH prelection element containing the AdditionalPropertiesDescriptor element and docs not recognize the AdditionalPropertiesDescriptor element ignores the entire DASH prelection element.

18. The non-transitory computer-readable recording medium of any of solutions 12-17, wherein the @interleaving attribute provides interleaving instructions to be used for interleaving samples or groups of samples of a current representation with other representations in a current preselection.

19. A method for storing bitstream of a video comprising: determining a value of an additional property descriptor (AdditionalPropertiesDescriptor) included in a Dynamic Adaptive Streaming over Hypertext Transfer Protocol (DASH) preselection element: generating a bitstream based on the determining; and storing the bitstream in a non-transitory computer-readable recording medium.

20. The non-transitory computer-readable recording medium of solution 19, wherein the AdditionalPropertiesDescriptor is an Essential Property Descriptor with a particular @schemeIdURI value, including “urn:mpeg:dash:preselection:essentialproperties:202x”.

21. The non-transitory computer-readable recording medium of any of solutions 19-20, wherein 202x is 2024, 2025, or 2026.

22. The non-transitory computer-readable recording medium of any of solutions 19-21, wherein the AdditionalPropertiesDescriptor contains an @interleaving attribute.

23. The non-transitory computer-readable recording medium of any of solutions 19-22, wherein the AdditionalPropertiesDescriptor contains an element, which contains an @interleaving attribute.

24. The non-transitory computer-readable recording medium of any of solutions 19-23, wherein a DASH client that recognizes the DASH prelection element containing the AdditionalPropertiesDescriptor element and docs not recognize the AdditionalPropertiesDescriptor element ignores the entire DASH prelection element.

25. The non-transitory computer-readable recording medium of any of solutions 19-24, wherein the @interleaving attribute provides interleaving instructions to be used for interleaving samples or groups of samples of a current representation with other representations in a current preselection.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks: magneto optical disks; and compact disc read-only memory (CD ROM) and Digital versatile disc-read only memory (DVD-ROM) disks. The processor and the memory can be supplemented by: or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data comprising:
adding, for a conversion between a visual media data and a bitstream, a value of an additional property descriptor included in a Dynamic Adaptive Streaming over Hypertext Transfer Protocol (DASH) preselection element; and
performing the conversion based on the additional property descriptor.

2. The method of claim 1, wherein the additional property descriptor is indicated as AdditionalPropertiesDescriptor.

3. The method of claim 1, wherein the additional property descriptor is an Essential Property Descriptor with a particular @schemeIdURI value.

4. The method of claim 3, wherein the particular @schemeIdURI value includes “urn:mpeg:dash:preselection:essentialproperties:202x”.

5. The method of claim 4, wherein 202x is 2024, 2025, or 2026.

6. The method of claim 1, wherein the additional property descriptor contains an interleaving attribute which provides interleaving instructions to be used for interleaving samples or groups of samples of a current representation with other representations in a current preselection.

7. The method of claim 6, wherein information provided in the interleaving attribute supersedes a value of an @order attribute in the DASH preselection element containing the additional property descriptor.

8. The method of claim 7, wherein the @order attribute specifies conformance rules for Representations in Adaptation Sets within the DASH preselection element.

9. The method of claim 6, wherein an XML syntax of the interleaving attribute is as follows: <xs:attribute name=“interleaving” type=“xs:string”/>.

10. The method of claim 6, wherein the interleaving attribute is indicated as @interleaving attribute.

11. The method of claim 1, wherein the additional property descriptor contains an element, which contains an interleaving attribute which provides interleaving instructions to be used for interleaving samples or groups of samples of a current representation with other representations in a current preselection.

12. The method of claim 11, wherein the interleaving attribute is indicated as @interleaving attribute.

13. The method of claim 1, wherein a DASH client that recognizes the DASH prelection element containing an additional property descriptor element and does not recognize the additional property descriptor element ignores the entire DASH prelection element.

14. The method of claim 13, wherein the additional property descriptor element is indicated as AdditionalPropertiesDescriptor element.

15. The method of claim 1, wherein an interleaving attribute is added to the DASH preselection element, immediately following an @order attribute, and the interleaving attribute provides interleaving instructions to be used for interleaving samples or groups of samples of a current representation with other representations in a current preselection.

16. The method of claim 15, wherein information provided in the interleaving attribute supersedes an @order value.

17. The method of claim 1, wherein the conversion includes encoding the visual media data into the bitstream.

18. The method of claim 1, wherein the conversion includes decoding the visual media data from the bitstream.

19. An apparatus for processing video data comprising: a processor; and a non-transitory memory with instructions thereon, wherein the instructions upon execution by the processor, cause the processor to:
add, for a conversion between a visual media data and a bitstream, a value of an additional property descriptor included in a Dynamic Adaptive Streaming over Hypertext Transfer Protocol (DASH) preselection element; and
perform the conversion based on the additional property descriptor.

20. A non-transitory computer-readable recording medium storing a bitstream of a video which is generated by a method performed by a video processing apparatus, wherein the method comprises:
adding, for a visual media data, a value of an additional property descriptor included in a Dynamic Adaptive Streaming over Hypertext Transfer Protocol (DASH) preselection element; and
generating the bitstream based on the additional property descriptor.
